(19) United States
(12) Patent Application Publication
(10) Pub. No.: US 2025/0323794 A1
(43) Pub. Date: Oct. 16, 2025

(54) METHOD, APPARATUS, AND NON-TRANSITORY MACHINE-READABLE STORAGE MEDIUM FOR AN VERIFICATION OF POSITIONAL INFORMATION

(71) Applicant: Intel Corporation, Santa Clara, CA (US)

(72) Inventor: Robert L. VAUGHN, Portland, OR (US)

(21) Appl. No.: 19/251,978

(22) Filed: Jun. 27, 2025

(51) Int. Cl. H04L 9/32

(52) U.S. Cl. CPC H04L 9/3236

(57) ABSTRACT

Provided is a computer-readable medium including computer-readable instructions. When the instructions are executed by a computer, the computer may implement a method. According to this method, a reference time value and a real time value are obtained based on hash calculation to positional information respectively, and a time-related verification on the positional information is performed based on the two time values.

### BACKGROUND

In a situation where positional information is needed, some actors may do some malicious actions to the process of positional information collection, so that incorrect positional information will be collected.

### BRIEF DESCRIPTION OF THE FIGURES

Some examples of apparatuses and/or methods will be described in the following by way of example only, and with reference to the accompanying figures, in which

FIG. 1 illustrates a schematic figure of an example of computing system 100;

FIG. 2 illustrates a flow chart of method 200 for performing time-related verification of an example of the application;

FIG. 2A illustrates a flow chart of method 200 for performing time-related verification of an example of the application;

FIG. 3 illustrates a flow chart of method 300 for performing time-related verification of an example of the application;

FIG. 3A illustrates a flow chart of method 300 for performing time-related verification of an example of the application;

FIG. 4 illustrates a flow chart of method 400 for performing time-related verification of an example of the application;

FIG. 5 illustrates a flow chat of verification of positional information of an example of the application.

FIG. 6 illustrates a block diagram of a system, device or apparatus 600 of an example of the application; and

FIG. 7 illustrates a block diagram of a system, device or apparatus 700 of an example of the application.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures identical or similar reference numerals refer to identical or similar elements and/or features, which may be identical or implemented in a modified form while providing the identical or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the identical combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the identical function. If a function is described below as implemented using multiple elements, further examples may implement the identical function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example,” “various examples,” “some examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage medium accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the identical or different examples. Furthermore, the terms “comprising,” “including,” “having,” and the like, as used with respect to examples of the present disclosure, are synonymous.

In some examples where a client device's positional information, such as geographic location, needs to be sent to another device, such as a remote server, a high-confidence, real-time attestation may be needed to resist spoofing on the positional information.

In some examples, a client's computing environment is not stable. For example, resource contention from an unsecure domain or untrusted zone, such as the Rich Execution Environment (REE), may impact the secure domain or trusted zone, such as Trusted Execution Environment (TEE).

TEE may refer to a secure and isolated area of a device's main processor designed to protect sensitive operations and data. It ensures confidentiality, integrity, and code execution trustworthiness, even if the rest of the system is compromised. TEE is with Hardware-enforced isolation from the main operating system. It may run trusted code, e.g., cryptographic functions, biometric matching, secure key handling. TEE may have its own secure boot, memory, and sometimes crypto accelerators. It cannot be or is difficult to access and/or modify by unauthorized applications or the REE. Some examples of TEE may include ARM TrustZone, Intel Software Guard Extensions (SGX), AMD Secure Processor and Qualcomm Secure Execution Environment (QSEE).

REE may refer to the main operating environment on a device, typically a general-purpose OS like Android, Linux, or Windows. It may handle applications and user-facing tasks, but is not inherently trusted for security-sensitive operations.

The impact may introduce some uncertainty in proving timely execution of location-dependent operations within a defined time window. This may make it challenging for the server to trust the reported positional information like location data and prevent malicious actors from providing false positional information.

In order to prevent false positional information, several technical solutions may be used. However, each of these solutions has its disadvantages. For example, Global Positioning System, GPS Signal Analysis may monitor the strength and quality of signals. However, some sophisticated spoofers may still mimic genuine signals. The solution Multi-Sensor Fusion may combine GPS with Inertial Measurement Unit (IMU)/Wi-Fi. However, sensors used in this solution may be simultaneously spoofed or have inherent inaccuracies. The solution Network-Based Location may use cell tower/Wi-Fi trilateration. However, the accuracy of this solution is less than GPS and it is vulnerable to network manipulation.

The above solutions alone cannot provide sufficiently strong, real-time proof against sophisticated spoofing attempts, especially when precise location and timing are critical. They lack a robust mechanism to verify the location acquisition process at the hardware level, such as the integrity and/or timeliness of the process, making the above solutions susceptible to manipulation.

In some examples, a robust mechanism may be provided for remote location attestation. The mechanism may be based on a secure domain or a trusted zone, such as the TEE, on the client device. According to one of the examples, an unsecure domain or untrusted zone, such as REE, may retrieve GPS data, exemplarily from a trusted and verified software or hardware environment, and a server-provided nonce, and then securely pass the both to the secure domain like the TEE. Within the isolated secure domain, a cryptographic hash of the GPS data and nonce is computed and returned to a server via the unsecure domain. To mitigate performance variability due to REE resource contention, the client may benchmark the secure domain's execution time during a specific system load. It may sample subsequent execution times and then prioritize or select those occurring during a same or similar load period. The prioritized or selected times sampled during a same or similar load period may be provided to a server for further evaluation. The server may analyze the prioritized or selected times to establish trust or non-trust in the positional information.

In some examples, a few technical schemes may be provided, where some or each of them may be used for the verification of positional information. The technical schemes may include Precise Time Synchronization, TEE Resource Isolation, REE Data Integrity and Performance Variability.

Precise Time Synchronization may achieve synchronized clocks across distributed systems over the internet facing unpredictable latency. It may mitigate the latency by focusing on the baselined execution time within the client's TEE rather than relying solely on network timing. A result of Precise Time Synchronization may be a Proof of Timed Events, indicating that an operation occurred on time, within a defined or expected length of time and is inside a trusted execution domain or context like the TEE.

TEE Resource Isolation may provide consistent performance for critical tasks when the REE-shared resources require careful management. This scheme may address the risk of performance variation in such a situation through performance baselining during low load.

REE Data Integrity may minimize or limit the window in which positional information like GPS data retrieved by the REE could be potentially manipulated before reaching the TEE. This scheme may rely on the TEE's secure processing of the data combined with a server-provided nonce.

Performance Variability may reduce the negative impacts to TEE's execution time caused by non-deterministic processes in the REE. This scheme may achieve it by sampling TEE execution times and prioritizing or selecting the sampled times from periods of low REE load.

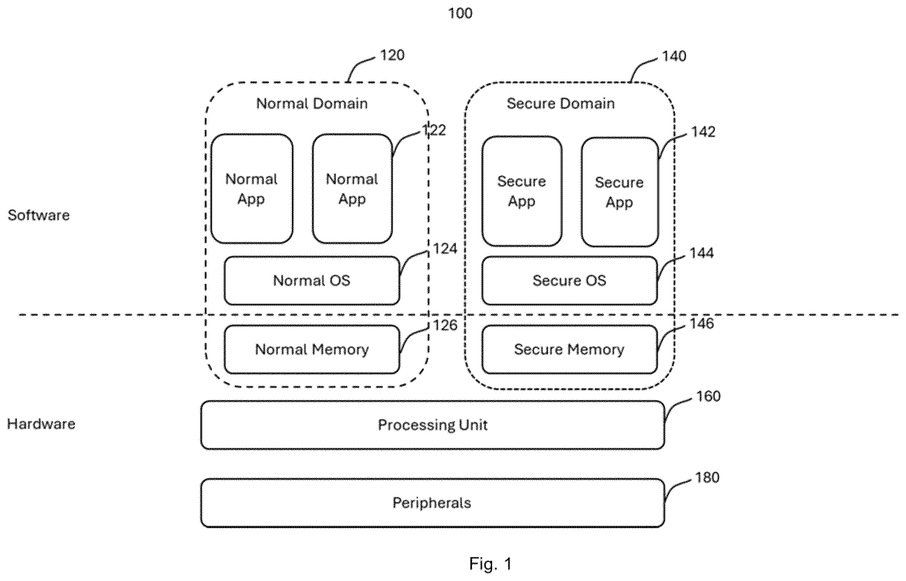

FIG. 1 illustrates a block diagram of computing system 100 of an example of the application. Computing system 100 may comprise two domains, normal domain 120 and security domain 140. It may further comprise memory 124 and normal memory 126, secure memory 146 processing unit 160, peripherals 180 and secure storage 190. In some examples, computing system 100 may be a personal computer, a laptop, a smartphone, a smart pad, a smart watch, or a server.

Processing unit 160 may comprise one or more processors. In some examples, the processing unit may be a system on a chip (SoC). In some other examples, processing unit may comprise a priority of SOCs. Peripherals 180 may comprise one or more input-output interfaces configured to couple with hardware peripheral devices or components.

Normal domain 120 may refer to a normal zone or untrusted zone. In some examples, it may be a Rich Execution Environment (REE). Normal domain 120 as illustrated in FIG. 1 may comprise normal applications 122 and normal operation system OS 124. Normal applications 122 are run based on normal OS 124. Normal OS 124 may be a untrusted OS or non-secure OS. Normal applications 122 may be untrusted or non-secure applications. Normal domain may further comprise normal memory 126, which may be used for normal domain 120.

Secure domain 140 may refer to a trusted zone. In some examples, it may be an Trusted Execution Environment (TEE). Normal domain 120 as illustrated in FIG. 100 may comprise secure applications 142 and secure operation system (OS) 144. Secure applications 142 are run based on secure OS 144. Secure OS 144 may be a trusted OS. Secure applications may be trusted applications. Secure domain may further comprise secure memory 146, which may be exclusively used for secure domain 140. In some examples, entities 142 in FIG. 1 may be secure processing modules, which may be secure applications or other secure entities like engines and/or interfaces.

Normal domain 120 may be optimized for functionality and performance but is exposed to potential threats, whereas secure domain 140 is optimized for confidentiality, integrity, and trustworthiness.

In some examples, normal domain 120 cannot access security domain 140 or the access to security domain 140 from normal domain 120 is strictly limited or managed, where secure domain may access normal domain. Security domain 140 may be used to separate secure data from normal domain, including normal OS 124 and normal applications 122 in normal domain 120.

Normal applications 122 may comprise messaging applications, game applications, browsers and UI applications, whereas secure applications 142 may comprise applications for digital rights management, biometric authentication and key handling. Normal applications 122 may be larger and exposed to malware, whereas secure applications 142 may be smaller and isolated from most or all components outside secure domain 140, especially normal domain.

Normal OS 124 may be full-featured but less secure, while secure OS 144 may be stripped down to handle high-assurance tasks with strict access control. Some examples of normal OS 124 may comprise Android, Linux and Windows, while some examples of secure OS 144 may comprise Open Portable Trusted Execution Environment (OP-TEE), Qualcomm Secure Execution Environment (QSEE) and Kinibi. Normal OS 124 may access non-secure peripherals, while secure OS 144 only has limited access, such as access to secure peripherals.

Normal memory 126 is subject to compromise and has no protection from malware in normal domain 120. Secure memory 146 may be used only by components in secure domain 140, such as secure apps 142 and secure OS 144. It may be isolated from normal domain 120 via some technical solutions and be used for cryptographic keys, authentication data and secure counters. In some examples, secure memory 146 may reside physically separate from normal memory 126.

In some examples, secure data, such as cryptographic keys, authentication data and secure counters, that is isolated by secure domain 140 from normal domain 120 may be stored in secure memory 146. Secure memory 146 may be a secure read-access memory (RAM), which may be implemented in several forms.

One implementation is dedicated on-chip RAM, which is small, fast memory integrated within the CPU or SoC and hard-wired to be accessible only by secure components. It may be used for boot-time operations, cryptographic key handling, and secure counters.

Another implementation is partitioned system random access memory (RAM), where a portion of normal memory, e.g., Dynamic RAD (DRAM), is allocated to secure domain during boot and protected by hardware mechanisms such as Memory Management Units (MMUs), Memory Protection Units (MPUs), or ARM's TrustZone Address Space Controller (TZASC), achieving that normal domain cannot access it.

A third implementation is secure SRAM or eSRAM, a type of static RAM that remains powered and isolated from normal domain, which may be used for storing operating system code, secure session states, and exception logs for secure domain.

Processing unit 160 may be shared by normal domain 120 and secure domain 140 in some examples. For example, it may work for normal domain 120 in a first time slot and may work for secure domain 140 in a second time slot.

In some examples, computing system 100 and/or processing module 142 in secure domain may be configured to perform method 200 for performing time-related verification on positional information of a device. The processing module 142 may be a secure application or a different software module.

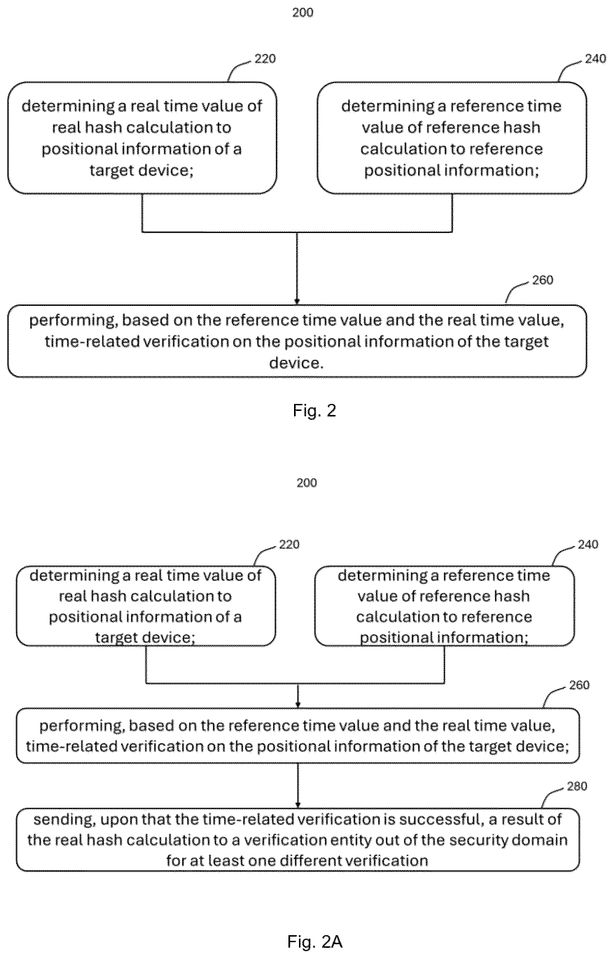

FIG. 2 illustrates a flow chart of method 200 for performing time-related verification of an example of the application. In some examples, method 200 may be performed by computing system 100. In some more specific examples, method 200 may be performed by a processing module 142 in secure domain 140. The processing module 142 may comprise a secure application, or one or more other software modules in secure domain 140.

According to FIG. 2, a reference time value of reference hash calculation to reference positional information is determined at operation 220, a real time value of real hash calculation to positional information of a target device is determined at operation 240, and a time-related verification on the positional information of the target device is performed at operation 260, where the verification is performed based on the reference time value and the real time value. If the real time value exceeds the reference time value by a certain amount, the verification may indicate that malicious actions might be performed to the positional information and the positional information might be false. It is because that if malicious actions have been performed, some additional time is needed for the malicious actions, which will cause the real time value to be longer than a normal value.

In some examples, the reference time value is determined when the security domain, such as secure domain 140, is in a low load state. In some other examples, the reference time value is determined when the security domain is in a different load state, such as a medium load state. In some examples, the low load state may refer to a state where a computational workload in the security domain is below 30%, 25%, 20%, 15%, 10%, 5% or 3%. In some examples, the medium load state may refer to a state where a computational workload in the security domain is higher than the low load state and lower than 50%, 55%, 60%, or 65%.

In some examples, the real time value is determined when the security domain is in the low load state. In other words, the real time value is determined in the same state when or during which the reference time value is determined. The same load state is not necessarily be the low load state and may be the medium load state.

In some examples, the load state of the real time value is determined is not necessarily same to the load state of the reference time value. For example, it is possible that the reference time value is determined when the computational workload in the security domain is in a low load state and the real time value is determined when the computational workload in the security domain is in a medium load state. In such a situation, a compensation value may be calculated based on the difference between the low load state and the medium load state. The compensation value may be used for the time-related verification to get a more accurate result.

In some examples, the reference time value is an average value of a plurality of time values caused by hash calculation to a plurality of pieces of reference positional information. For example, the reference time value may be an average value of 10 time values which are produced by 10 hash calculations to 10 pieces of reference positional information.

In some other examples, the reference time value is a minimal value of a plurality of time values caused by hash calculation to a plurality piece of reference positional information. For example, the reference time value may be a minimal value of 10 time values which are produced by 10 hash calculations to 10 pieces of reference positional information.

In yet some other examples, the reference time value is an average value of a first plurality of time values among a second plurality of time values, where the first plurality of time values may be a portion of the second plurality of time values and each of the first plurality of time values is smaller than a threshold value. The reference time value determined in this way will be a reliable one.

In some examples, method 200 may further comprise operation 280 as illustrated in FIG. 2A. At operation 280, a result of the real hash calculation is sent to a verification entity out of the security domain for at least one different verification. The verification entity out of the security domain may be a server providing a service to clients, where the service may be banking, online shopping, or online social media. In some examples, the verification entity may even be in normal domain 120, where a normal application 122 may implement some functions of a server. In some other examples, the verification entity may be a remote server resides in a remote data center of a service provider.

In some examples, the reference time value may refer to a length of a time period that starts at receipt of the information initiating the reference hash calculation and ends at an end of calculating a hash value based on received positional information for the reference hash calculation and received information initiating the reference hash calculation. The information initiating the reference hash calculation may include a first nonce that will be used to make the hash calculation to the received positional information. The first nonce, which may be referred to as a nonce value, may be assigned or issue an entity requesting positional information of a client device, such as a server of a service provider.

In some examples, the real time value of real hash calculation to positional information of a target device may be calculated or determined in the same way, whereas the values used in the process are of or associated with the target device. For example, the real time value refers to a length of a real time period that starts at receipt of the information initiating the real hash calculation and ends at an end of calculating a hash value based on received positional information for the real hash calculation and received information initiating the real hash calculation. The processing module may be configured to receive the positional information of the real positional information during the real time period, or even before the start of the real time period. In some examples, the received information initiating the real hash calculation comprises a second nonce value.

In some examples, the above calculation or determination process may be performed a plurality of times to positional information of same or different devices to obtain a plurality of candidate or sampling time values. The reference time value will be finally calculated or determined based on the plurality of candidate or sampling time values. In some other examples, reference time value is determined based on only one time execution of the above process to one piece of positional information of one device.

In some examples, the positional information is received by the processing module during the time period. In some other examples, the positional information may be received by the processing module before the start of the time period.

In some examples, the positional information may be Global Positioning System (GPS) data indicating position or location of an entity. Some other data that can indicate position or location of an entity may also be used as the positional information, such as data provided by the Beidou system, Galileo system

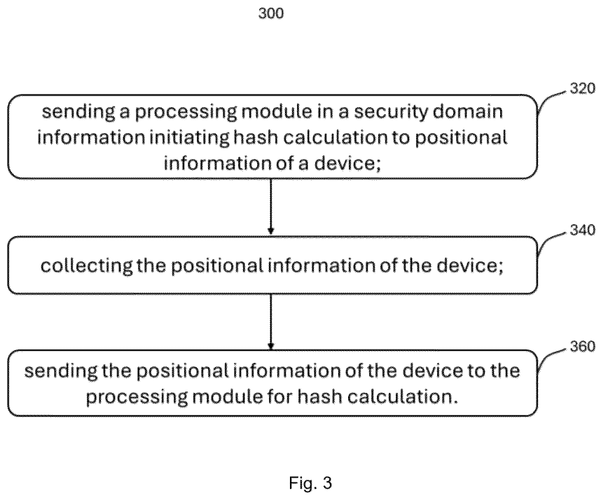

FIG. 3 illustrates a flow chart of method 300 for performing a verification of positional information of an example of the application. In some examples, method 300 may be performed by a device, such as a personal computer, a smartphone, a smart watch, a smart pad, and so on. In some more specific examples, method 300 may be performed by a software module run in the device, where the software module is run by a processor in device reading a machine-readable program stored in a memory. In some examples, the device is a device used by a client to access a service provided by a service provider. Therefore, the software module may be referred to as a client module in some examples. Some examples of the service include an online banking service, an online game service, an online shopping service and an online social media service.

According to an example of method 300, information initiating hash calculation to positional information of a device is sent to a processing module in a secure domain at operation 320, the positional information of the device is collected at operation 340, and the positional information of the device is sent to the processing module in the secure domain at operation 360. Based on method 300, the processing module may be triggered to do a time-related verification on the positional information and provided further information needed for the verification.

In some examples, method 300 may be used to generate the reference time value described in method 200 and in other examples of the application. In such a situation, the device described in method 300 may be a reference device, the positional information is reference positional information, and the hash calculation is hash calculation for determining a reference time value.

In some other examples, method 300 may be sued to generate the real time value described in method 200 and in other examples of the application. In such a situation, the device described in method 300 may be a target device, the positional information is real positional information, and the hash calculation is hash calculation for determining a real time value.

The reference time value may serve as a baseline for an analysis to a real time value. It is to determine whether the positional information of a target device has been attacked by some malicious behaviors. Therefore, in some examples, method 300 may include both the operations associated with determining or calculating the reference time value and the operations associated with determining or calculating the real time value.

In some examples, method 300 may include some further operations as illustrated in FIG. 3A. For example, the further operations may include receiving a request for location validation at operation 310, sending a request to a server for a nonce value at operation 312 and receiving the nonce value at operation 314, wherein the information initiating hash calculation to positional information of a device comprises the nonce value. Based on these operations, the software module, which may be referred to as a client module, may obtain the nonce, which may be referred to as a nonce value, that will be used to compute the reference time value or the real time value.

In some examples, as illustrated in FIG. 3A, method 300 may further include receiving a hashed value from the processing module as a consequence of sending the positional information to the processing module at operation 380; and sending the received hashed value to an entity for further verification on the collected positional information of device at operation 382. As a result of operations 380 and 382, the entity receiving the hashed value may make a further verification on whether the positional information of the target device is false.

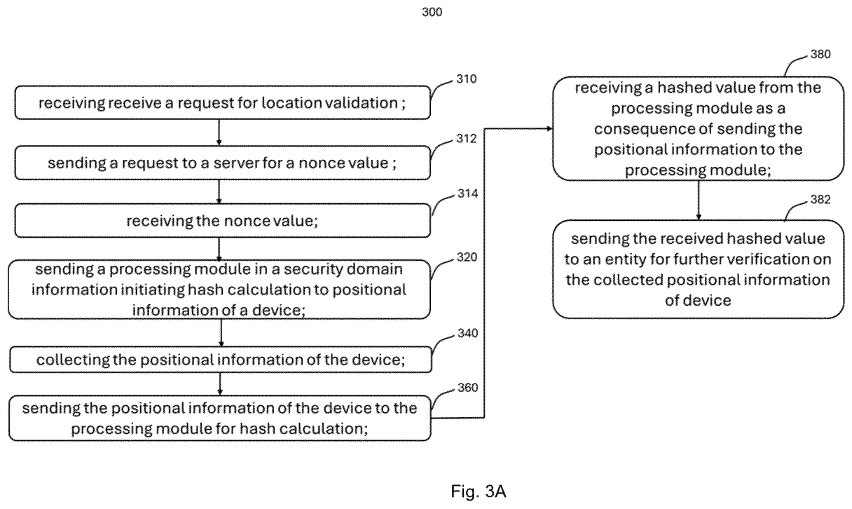

FIG. 4 illustrates a flow chart of method 400 for performing a verification of positional information of an example of the application. In some examples, method 400 may be performed by a device, such as a server. In some more specific examples, method 400 may be performed by a processor in the device reading a computer-readable program stored in a memory.

In some examples, as illustrated in FIG. 4, method 400 may include assigning, in response to a nonce request, a nonce value for a hash calculation to positional information of a target device at operation 420, receiving a hash result at operation 440, and determining, based on the hash result, whether the positional information is false at operation 460.

In some examples, the nonce request may be from a client device. In some more specific examples, it may be from a client module or a browser application run on the client device. The nonce request may be caused by a server that requires the positional information of the client device for client authentication or other actions associated with the client device. The client device may be the target device.

In some examples, the hash result may also be received from the client device because the hash calculation is performed in a secure domain in the client device.

In some examples, the determination at operation 460 may be performed based on a first time of receiving the request and a second time of receiving the hash result. In a more specific example, a time period between the first time and the second time may be determined. Then the determined time period may be compared to a reference or baseline time value. If the determined time period is longer than the reference or baseline time value, it may be determined that the positional information is false, though the positional information passes the verification performed by method 200.

In some examples, the determination at operation 460 may be performed based on the nonce value assigned for the request and the received hash result. In a more specific example, a new hash computation may be performed using the nonce value assigned for the request and some expected characteristics of legitimate positional information. If a result of new hash calculation matches the one received, this confirms the integrity and freshness of the positional information or indicates that the possibility of false positional information is low.

In some examples, the above two verification solutions may be used together to get a more accurate result. For example, when each of the two verification solutions gives a positive conclusion indicating the possibility of false positional information is low, the result of method is that the positional information is true; when each of the two verification solutions gives a negative conclusion indicating that the possibility of false positional information is high, the result of method 400 is that the positional information is true; and when one verification is positive and the other one is negative, the result of method 400 may be that the positional information is doubtful or undetermined.

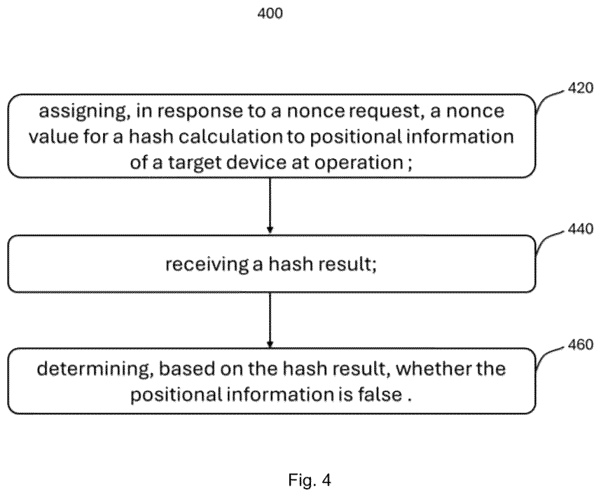

FIG. 5 illustrates a flow chat of verification of positional information of an example of the application.

In some examples, Browser 5_20 may be a normal application 122 in FIG. 1, Client 5_40 may be a different normal application 122 in FIG. 1, TEE_Module 580 may be a secure application in FIG. 1, GPS Receiver 5_100 may be GPS hardware unit including an antenna, and Server 5_60 may be a server providing an online service to a client.

At operation 501, Browser 5_20 requests location validation of a device. In particular, a browser may send a request message to Client 5_40, requesting the location validation. In some examples, Browser 5_20 may be a browser application like Google Chrome, Microsoft Internet Explorer (IE) running on a client terminal like a personal computer or a smartphone. A plurality of services provided to a client might need the correct positional information of the client. The services may be associated with user verification and/or user authentication, and may be run by a bank, an online shopping company, an online social media company, etc. The request sent by the browser may be triggered by the service provider or a default configuration of the browser. Client 5_40 may be an software application or module that may communicate with browser 5_20, server 560, TEE_Module 5_80 and GPS_Receiver 5_100.

At operation 502, Client 5_40 may send a message to Server 5_60 to request a nonce for a further hash calculation. The request is sent as a response to the request received at operation 501 from Browser 5_20.

At operation 503, Server 5_60 may assign a nonce in response to the request received at operation 502 and then send the nonce back to Client 5_40.

At operation 504, Client 5_40 may send a message including the nonce to TEE_Module 5_80 to initiate a timed event. The timed event may be for a hash calculation using the nonce. TEE_Module 5_80 may be an software application, module or component, possibly firmware-assisted, running in the TEE. It may be a trusted program or service running inside the TEE that performs secure, time-sensitive computations without interference from the REE. In some examples, TEE_Module 5_80 may start to measure the starting time of the event upon receipt of the message received at operation 504. In some examples, TEE_Module 5_80 is in the device where Browser 5_20 resides. Particularly, it may be in a System on a Chip (SoC) in the device.

At operation 505, Client 5_40 may fetch GPS data from a GPS_Receiver 5_100. The GPS receiver may be a GPS component having an antenna configured to communicate with a GPS system and receive GPS data indicating the position of the GPS component. In some examples, GPS_Receiver 5_100 is equipped in the device where Brower 5_20 resides. The GPS data provided by GPS_Receiver 5_100 indicates the positional information of the device where Brower 5_20 resides. In a particular example, Server 5_60 sends a message requesting GPS data to GPS_Receiver 5_100.

At operation 506, GPS_Receiver 5_100 sends the GPS data requested by Client 5_40 at operation 505 to Client 5_40.

At operation 507, Client 5_40 send the GPS data obtained from GPS_Receiver 5_100 to TEE_Module 5_80.

At operation 508, TEE_Module 5_80 may calculate a hash value based on the GPS data received at operation 507 and the nonce received at operation 504.

TEE_Module 5_80 may further determine how much time is used for calculating the hash value. In some examples, the time period for calculating the hash value may be from a starting time set in response to the receipt of the request for initiating the timed event at operation 504. In some examples, an ending point of the time. In some examples, operation and operation 505 may be performed substantially at the same time. In some examples,

After the time value used for calculating the hash value is determined, TEE_Module 5_80 may evaluate whether the determined time value is within a range of acceptable time. The range of acceptable time may be set by a reference time value of reference hash calculation to reference positional information. For example, if the determined time value is no more than the reference time value, it indicates that the time used for fetching the GPS data and calculating the hash value is within a reasonable and safe length of time so that the risk that malicious actions have been made is low. The calculation of the hash value is made by TEE_Module 5_80 and therefore is extremely difficult to control by malicious actors. Such a nature gives a trustful or reliable ending time of a process, making a solution relying on the reference time value to be robust to potential risks. In some examples, the calculation at operation 508 is made when the TEE is in a low load state. It is because the reference time value is also determined when the TEE is in the same low load state. In some examples, the calculation at operation 508 cannot be made when the TEE is in a low load state due to some objective reasons. In such a situation, the acceptable time range may be set longer than the range of the reference time value to avoid incorrect evaluation.

At operation 509, TEE_Module 5_80 sends the hashed value to Client 5_40 upon that the time-based evaluation at operation 508 succeeds. When the time-based evaluation succeeds, it indicates that no malicious actions associated with positional information have been anticipated or detected.

At operation 510, Client 5_40 sends the received hashed value to Server 5_60 for further verification.

At operation 511, Server 5_60 performs a further verification. In some examples, although Server 5_60 does not know the exact contents of the GPS data used for hash calculation, it may know some characteristics of the GPS data, which enables Server 5_60 to do a hash calculation based on the nonce it assigns or issues and the characteristics. Based on the calculated hash value and the received hash value, it may the further verification. In some examples, Server 5_60 may check whether an overall time period used to obtain the positional information of a client device falls within a predetermined acceptable period. In some examples, the overall time period may start from a request sent out by Server 5_60 for the positional information and end at receipt of the hashed value at operation 510. In some examples, Server 5_60 may use the above two methods together and the result of if each of the two methods is positive, Server 5_60 may conclude that the further verification succeeds and it is highly possible that the positional information is true.

At operation 512, Server 5_60 sends a message indicating that the location or position of the client device is validated at 512a when the further verification performed at 511 is positive; and Server 5_60 sends a message indicating that the location or position of the client device is not validated at 512b when the further verification performed at 511 is negative.

In some examples, a phase of device provisioning and baseline establishment is provided for the contents associated with FIG. 5 and for other examples of the application.

This phase may establish the baseline trust and performance characteristics of the client device. For example, it may provide secure determination of the baseline execution time (t) for the TEE's core cryptographic operation, such as hashing the nonce and GPS data. It may be achieved by running the hashing algorithm by the TEE_Module within the isolated TEE under controlled conditions where the REE exhibits minimal resource utilization. Multiple iterations may be performed to account for minor variations, and the minimum observed execution time may be securely recorded within the TEE or a trusted storage accessible only by the TEE. This baseline (t), which serves a reference, represents the TEE's near-ideal processing speed for the specific cryptographic task relevant to location attestation, providing a crucial benchmark for subsequent real-time evaluations. The secure material of the device, verified during provisioning, may improve and protect the integrity of the TEE and the baseline measurement process.

In some examples, a phase of initiation of attestation and nonce generation is provided for the contents associated with FIG. 5 and for other examples of the application.

In this phase, a server, such as a server of a service provider like an Acme Bank, may need to validate client Alice's location. The initiation of a time-bound trusted location attestation (TBLA) process may be a standard or normal security measure. However, the subsequent generation and delivery of a unique, cryptographically secure nonce to the client may introduce a challenge-response element. This nonce, unpredictable to the client beforehand, is novel in its direct integration with the time-sensitive location verification within the TEE. By requiring the TEE to process this specific, just-in-time nonce along with the GPS data, the system or solution may prevent the simple replay of pre-computed hashes or location data, enhancing the robustness against spoofing attacks. The secure transmission of the nonce to the client's TBLA client, such as operations 503 in FIG. 5, improves integrity and security of the nonce before the nonce is passed to the TEE.

In some examples, a phase of Client Interaction and GPS Data Acquisition is provided for the contents associated with FIG. 5 and for other examples of the application.

In this phase, a client, such as Client_5_40, may act as an intermediary and receive an attestation request, such as the request of operation 501, and a nonce, such as the nonce of operation 503. The client may timely retrieve GPS data specifically for the TEE's processing. Upon receiving the nonce and initiating the timed event, such as operation 504, within the TEE, the client promptly fetches, such as operations 505 and 506, the current GPS coordinates from the device's GPS receiver. The near-simultaneous triggering of the TEE's timed operation and the GPS data acquisition is to establish or improve the temporal relevance of the location information being attested to. This tight coupling may minimize or reduce the window of opportunity for manipulation between location sensing and secure processing.

In some examples, a phase of TEE-based timed hashing and evaluation is provided for the contents associated with FIG. 5 and for other examples of the application.

In this phase, the TEE, such as the TEE_Module 5_80, performs a cryptographic hash operation upon receiving the nonce and GPS data. The TEE may measure the execution time of this hashing process. This measured time may be then compared against the pre-established baseline (t), which may be understood as a reference time value. The TEE may only return the resulting hash to the client if the execution time falls within a narrow, pre-defined range (x) established or determined based on the baseline (t). This time-bound execution within the secure TEE may provide a novel execution time receipt. This receipt may indicate or imply that the cryptographic operation was performed locally and within a timeframe. If the GPS data were spoofed from a distant location, it is difficult to get such a receipt because the spoofing will need some external computational assistance and thus will cause significant network latency, which will delay the receipt. If the first execution of the cryptographic operation inside the Trusted Execution Environment (TEE) takes too long, i.e., exceeds the expected or acceptable time range, the TEE may make the execution, such as operations 502 to 508, a few more times. The repetition of the execution may account for minor and legitimate fluctuations, such as momentary spikes in CPU usage or memory load, which can slightly affect performance, even in a mostly isolated TEE.

In some examples, a phase of server evaluation and attestation outcome is provided for the contents associated with FIG. 5 and for other examples of the application.

In this phase, the server may receive the hash from the client, i.e. operation 510. The server may performed a two-pronged evaluation. First, the server may verify the cryptographic integrity of the received hash using the nonce assigned or issued by itself. Second, the server may evaluate the overall time taken for the entire TBLA process (p), from initiating the request to receiving a valid hash. In some examples, initiating the request to receive the hash may refer to a request sent by the server to the browser for the positional information. If this overall time is within an acceptable limit, which accounts for expected network latency and the client's TEE processing time, the server may gain a high degree of confidence that client Alice's reported location is genuine. The constraints enforced by the TEE's execution time receipt, combined with the server's end-to-end timing verification, contributes to the remote location attestation that significantly enhances resistance against sophisticated spoofing techniques.

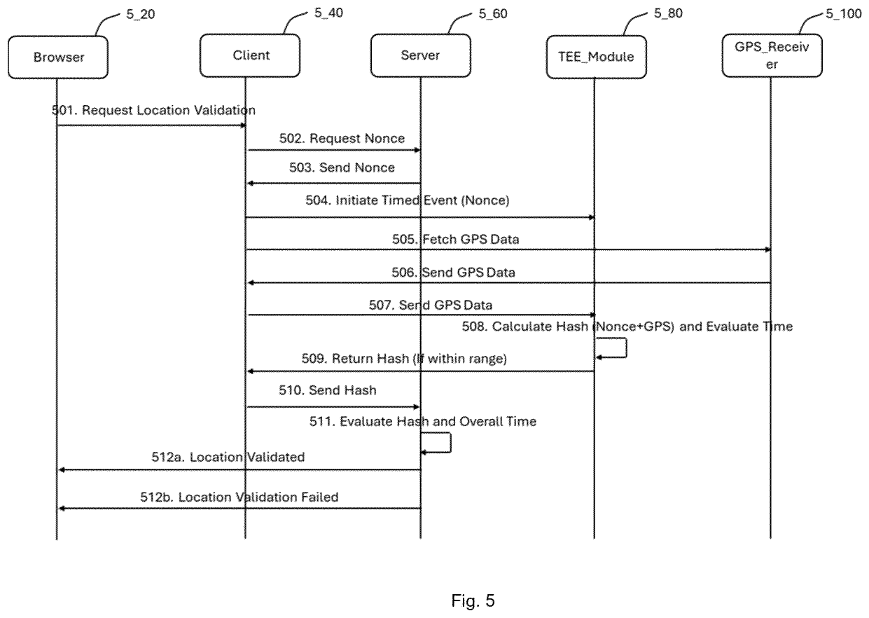

FIG. 6 illustrates a block diagram of a system, device or apparatus 600 of an example of the application. In some examples, the system, device or apparatus 600 is configured to perform method 400, work as the server 5_60 in FIG. 5, and other server or entity having the functions of a server in some or all examples of the application.

In some examples, apparatus 600 may include interfaces 620, such as 620a and 620b, and processing circuitry 640. Apparatus 600 may be configured to implement, based on the cooperations between one or more tangible computer-readable (“machine-readable”) non-transitory storage medium 650 and one or more processors 660 of the processing circuitry 640, operations and/or functionalities described with reference to the FIGS. 1 to 5. For example, the operations and/or functionalities may include each and every operation of method 400. The storage medium 650 may include all the machine-readable instructions for implementing method 400 and operations performed by the server in FIG. 5. In some examples, medium may refer to memory or media.

In some examples, apparatus 600 may perform the above implementations when the computer-executable instructions, such as the logic or computer program 670, are executed by one or more processors 660. In some examples, the interfaces 620 are interface means and the processing circuitry 640 is processing means 640.

In some examples, the interfaces 620 may be configured to communicate with other apparatuses. In some examples, interfaces 620 may include one or more wireless interfaces including antennas, such as MIMO antennas, and/or wired interfaces, such as USB serial interfaces and/or RJ45 interfaces. The wireless interfaces may be configured to transmit and/or receive Wi-Fi signals, 3GPP signals and/or other wireless signals. The wired interfaces may be configured to receive signals transmitted via fiber, coaxial cables and other mediums.

In some examples, one or more processors 660 may be General Purpose CPUs, Mobile Processors, Server and Data Center Processors, Embedded Processors, Graphics Processing Units (GPUs), Specialized Processors, Microcontrollers, Field-Programmable Gate Arrays (FPGAs), Digital Signal Processors (DSPs), application-specific integrated circuits (ASICs), integrated circuits (ICs) and/or other circuitries having the capability of performing the operations of the controller in each and every example of this disclosure.

In some examples, the phrase “computer-readable non-transitory storage medium” may be directed to include all machine and/or computer readable medium, with the sole exception being a transitory propagating signal.

In some examples, the storage medium 650 may include one or more types of computer-readable storage medium capable of storing data, including volatile memory, non-volatile memory, removable or non-removable memory, erasable or non-erasable memory, writeable or re-writeable memory, and the like. For example, storage medium 650 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some examples, the logic or computer program 670 may include instructions, data, and/or code, which, if executed by a machine, such as implemented by one or more processors in an apparatus, may cause the machine to perform a method, process, and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some examples, each of components 620, 640, 650, 660 and 670 in the apparatus 600 may be implemented by a corresponding means capable of implementing the functions of the above components. In some examples, storage media 650 is not included in apparatus 600 because processors 660 may read logic or computer program 670 from a storage media out of the apparatus 600.

In some examples, the logic or computer program 670 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner, or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

In some examples, interfaces 620, storage media 650 and processors 660 communicate with each other via bus. In some other examples, some of these entities have direct communicative connections with each other.

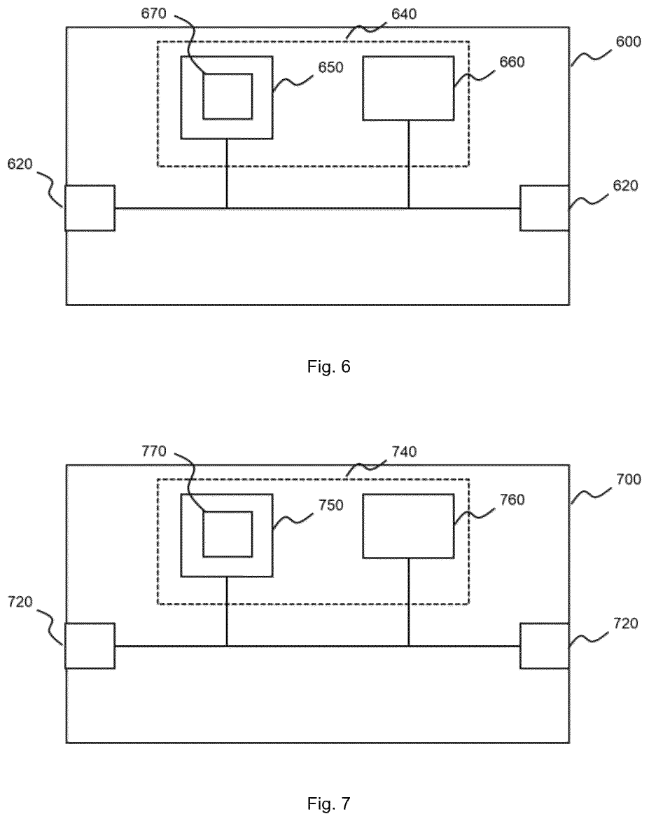

FIG. 7 illustrates a block diagram of a system, device or apparatus 700 of an example of the application. In some examples, system, device or apparatus 700 may be computing system or present some aspects of computing system 100.

In some examples, system, device or apparatus 700, which may be referred to as system hereinafter, may include interfaces 720, such as 720a and 720b, and processing circuitry 740. System 700 may be configured to implement, based on the cooperations between one or more tangible computer-readable (“machine-readable”) non-transitory storage medium 750 and one or more processors 760 of the processing circuitry 740, operations and/or functionalities described with reference to the FIGS. 1 to 5. For example, the operations and/or functionalities may include each and every operation of method 200 and 300. The storage medium 750 may include all the machine-readable instructions for implementing methods and 300, and operations performed by TEE_Module and Client in FIG. 5. In some examples, medium may refer to memory or media. In some examples, processing circuitry may be the processing unit 160. In some examples, storage medium 750 may be at least one of normal memory 126 or secure memory 146.

In some examples, system 700 may perform the above implementations when the computer-executable instructions, such as the logic or computer program 770, are executed by one or more processors 760. In some examples, the interfaces 720 are interface means 720 and the processing circuitry 740 is processing means 740.

In some examples, the interfaces 720 may be configured to communicate with other apparatuses or devices. In some examples, interfaces 720 may include one or more wireless interfaces including antennas, such as MIMO antennas, and/or wired interfaces, such as USB serial interfaces and/or RJ45 interfaces. The wireless interfaces may be configured to transmit and/or receive Wi-Fi signals, 3GPP signals and/or other wireless signals. The wired interfaces may be configured to receive signals transmitted via fiber, coaxial cables and other mediums.

In some examples, one or more processors 660 may be General Purpose CPUs, Mobile Processors, Server and Data Center Processors, Embedded Processors, Graphics Processing Units (GPUs), Specialized Processors, Microcontrollers, Field-Programmable Gate Arrays (FPGAs), Digital Signal Processors (DSPs), application-specific integrated circuits (ASICs), integrated circuits (ICs) and/or other circuitries having the capability of performing the operations of the controller in each and every example of this disclosure.

In some examples, the phrase “computer-readable non-transitory storage medium” may be directed to include all machine and/or computer readable medium, with the sole exception being a transitory propagating signal.

In some examples, the storage medium 750 may include one or more types of computer-readable storage medium capable of storing data, including volatile memory, non-volatile memory, removable or non-removable memory, erasable or non-erasable memory, writeable or re-writeable memory, and the like. For example, storage medium 750 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some examples, the logic or computer program 770 may include instructions, data, and/or code, which, if executed by a machine, such as implemented by one or more processors in a computing system, may cause the machine to perform a method, process, and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some examples, each of components 720, 740, 750, 760 and 770 in the system 700 may be implemented by a corresponding means capable of implementing the functions of the above components. In some examples, storage media 750 is not included in system 700 because processors 760 may read logic or computer program 770 from a storage media out of the system 700.

In some examples, the logic or computer program 770 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner, or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

In some examples, interfaces 720, storage media 750 and processors 760 communicate with each other via bus. In some other examples, some of these entities have direct communicative connections with each other.

In some examples, each operation in the application may be implemented by an exclusively corresponding means. For example, if a system or a device performs N operations, the system or the device may include N means, each performing one corresponding operation.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and sub-combinations with one another. The disclosed methods, apparatuses, and systems are not limited to any specific aspect or feature or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

In the following, some examples of the application is provided.

An example (e.g. example 1) relates to a non-transitory machine-readable storage medium including program code, when executed, to cause a machine to implement a processing module in a secure domain, wherein the processing module is configured to: determine a reference time value of reference hash calculation to reference positional information; determine a real time value of real hash calculation to positional information of a target device; and perform, based on the reference time value and the real time value, a time-related verification on the positional information of the target device.

An example (e.g., example 2) relates to a previously described example (e.g., example 1) or to any of the examples described herein, wherein the reference time value is determined when the security domain is in a low load state.

An example (e.g., example 3) relates to a previously described example (e.g., example 2) or to any of the examples described herein, wherein the real time value is determined when the security domain is in the low load state.

An example (e.g., example 4) relates to a previously described example (e.g., example 1 or 2) or to any of the examples described herein, wherein the low load state refers to a state where a computational workload in the security domain is below 30%, 25%, 20%, 15%, 10%, 5% or 3%.

An example (e.g., example 5) relates to a previously described example (e.g., any one of examples 1 to 4) or to any of the examples described herein, wherein the reference time value is an average value of a plurality of time values caused by hash calculation to a plurality of pieces of reference positional information.

An example (e.g., example 6) relates to a previously described example (e.g., any one of examples 1 to 4) or to any of the examples described herein, wherein the reference time value is a minimal value of a plurality of time values caused by hash calculation to a plurality of pieces of reference positional information.

An example (e.g., example 7) relates to a previously described example (e.g., any one of examples 1 to 6) or to any of the examples described herein, wherein the processing module is further configured to: send, upon that the time-related verification is successful, a result of the real hash calculation to a verification entity out of the security domain for at least one different verification.

An example (e.g., example 8) relates to a previously described example (e.g., any one examples 1 to 7) or to any of the examples described herein, wherein the reference time value refers to a length of a reference time period that starts at receipt of the information initiating the reference hash calculation and ends at an end of calculating a hash value based on received positional information for the reference hash calculation and received information initiating the reference hash calculation.

An example (e.g., example 9) relates to a previously described example (e.g., example 8) or to any of the examples described herein, wherein the processing module is configured to receive the positional information of the reference positional information during the reference time period.

An example (e.g., example 10) relates to a previously described example (e.g., example 8 or 9) or to any of the examples described herein, wherein the information initiating the reference hash calculation comprises a first nonce value.

An example (e.g., example 11) relates to a previously described example (e.g., any one of examples 1 to 10) or to any of the examples described herein, wherein the real time value refers to a length of a real time period that starts at receipt of the information initiating the real hash calculation and ends at an end of calculating a hash value based on received positional information for the real hash calculation and received information initiating the real hash calculation.

An example (e.g., example 12) relates to a previously described example (e.g., example 11) or to any of the examples described herein, wherein the processing module is configured to receive the positional information of the real positional information during the real time period.

An example (e.g., example 13) relates to a previously described example (e.g., example 11 or 12) or to any of the examples described herein, wherein the received information initiating the real hash calculation comprises a second nonce value.

An example (e.g., example 14) relates to a non-transitory machine-readable storage medium including program code, when executed, to cause a machine to: send a processing module in a security domain information initiating hash calculation to positional information of a device; collect the positional information of the device; and send the positional information of the device to the processing module for hash calculation.

An example (e.g., example 15) relates to a previously described example (e.g., example 14) or to any of the examples described herein, wherein the device is a reference device, the positional information is reference positional information, and the hash calculation is hash calculation for determining a reference time value.

An example (e.g., example 16) relates to a previously described example (e.g., example 14) or to any of the examples described herein, wherein the device is a target device, the positional information is real positional information, and the hash calculation is hash calculation for determining a real time value.

An example (e.g., example 17) relates to a previously described example (e.g., any one of examples 14 to 16) or to any of the examples described herein, wherein the machine is further caused by the program code to: receive a request for location validation; send a request to a server for a nonce value; and receive the nonce value, wherein the information initiating hash calculation to positional information of a device comprises the nonce value.

An example (e.g., example 18) relates to a previously described example (e.g., any one of examples 14 to 17) or to any of the examples described herein, wherein the machine is further caused by the program code to: receive a hashed value from the processing module as a consequence of sending the positional information to the processing module; and send the received hashed value to an entity for further verification on the collected positional information of device.

An example (e.g., example 19) relates to a non-transitory machine-readable storage medium including program code, when executed, to cause a machine to: assign, in response to a nonce request, a nonce value for a hash calculation to positional information of a target device; receive a hash result; and determine, based on the hash result, whether the positional information is false.

An example (e.g., example 20) relates to a previously described example (e.g., example 19) or to any of the examples described herein, wherein the determination is based on a first time of receiving the request and a second time of receiving the hash result.

An example (e.g., example 21) relates to a previously described example (e.g., example 19 or 20) or to any of the examples described herein, wherein the determination is based on the nonce value assigned for the request and the received hash result.

An example (e.g., example 22) relates to a computing system, comprising a host processing unit and a security domain comprising a secure processing module, wherein the secure processing module is configured to: determine a reference time value of reference hash calculation to reference positional information; determine a real time value of real hash calculation to positional information of a target device; and perform, based on the reference time value and the real time value, time-related verification on the positional information of the target device.

An example (e.g., example 23) relates to a previously described example (e.g., example 22) or to any of the examples described herein, wherein the reference time value is determined when the security domain is in a low load state.

An example (e.g., example 24) relates to a previously described example (e.g., example 23) or to any of the examples described herein, wherein the real time value is determined when the security domain is in the low load state.

An example (e.g., example 25) relates to a previously described example (e.g., example 23 or 24) or to any of the examples described herein, wherein the low load state refers to a state where a computational workload in the security domain is below 30%, 25%, 20%, 15%, 10%, 5% or 3%.

An example (e.g., example 26) relates to a previously described example (e.g., any one of examples 22 to 25) or to any of the examples described herein, wherein the reference time value is an average value of a plurality of time values caused by hash calculation to a plurality piece of reference positional information.

An example (e.g., example 27) relates to a previously described example (e.g., any one of examples 22 to 26) or to any of the examples described herein, wherein the reference time value is a minimal value of a plurality of time values caused by hash calculation to a plurality piece of reference positional information.

An example (e.g., example 28) relates to a previously described example (e.g., any one of examples 22 to 27) or to any of the examples described herein, wherein the processing module is further configured to:
send, upon that the time-related verification is successful, a result of the real hash calculation to a verification entity out of the security domain for at least one different verification.

An example (e.g., example 29) relates to a previously described example (e.g., any one of examples 22 to 28) or to any of the examples described herein, wherein the reference time value refers to a length of a reference time period that starts at receipt of the information initiating the reference hash calculation and ends at an end of calculating a hash value based on received positional information for the reference hash calculation and received information initiating the reference hash calculation.

An example (e.g., example 30) relates to a previously described example (e.g., example 29) or to any of the examples described herein, wherein the secure processing module is configured to receive the positional information of the reference positional information during the reference time period.

An example (e.g., example 31) relates to a previously described example (e.g., example 29 or 30) or to any of the examples described herein, wherein the information initiating the reference hash calculation comprises a first nonce value.

An example (e.g., example 32) relates to a previously described example (e.g., any one of examples 27 to 30) or to any of the examples described herein, wherein the real time value refers to a length of a real time period that starts at receipt of the information initiating the real hash calculation and ends at an end of calculating a hash value based on received positional information for the real hash calculation and received information initiating the real hash calculation.

An example (e.g., example 33) relates to a previously described example (e.g., example 32) or to any of the examples described herein, wherein the secure processing module is configured to receive the positional information of the real positional information during the real time period.

An example (e.g., example 34) relates to a previously described example (e.g., example 32 or 33) or to any of the examples described herein, wherein the received information initiating the real hash calculation comprises a second nonce value.

An example (e.g., example 35) relates to a computing system comprising a processing unit and a normal domain comprising a module, wherein the module is configured to: send a processing module in a security domain information initiating hash calculation to positional information of a device; collect the positional information of the device; and send the positional information of the device to the processing module for hash calculation.

An example (e.g., example 36) relates to a previously described example (e.g., example 35) or to any of the examples described herein, wherein the device is a reference device, the positional information is reference positional information, and the hash calculation is hash calculation for determining a reference time value.

An example (e.g., example 37) relates to a previously described example (e.g., example 35 or 36) or to any of the examples described herein, wherein the device is a target device, the positional information is real positional information, and the hash calculation is hash calculation for determining a real time value.

An example (e.g., example 38) relates to a previously described example (e.g., any one of examples 35 to 37) or to any of the examples described herein, wherein the module is configured to: receive a request for location validation; send a request to a server for a nonce value; and receive the nonce value, wherein the information initiating hash calculation to positional information of a device comprises the nonce value.

An example (e.g., example 39) relates to a previously described example (e.g., any one of examples 35 to 38) or to any of the examples described herein, wherein the module is configured to: receive a hashed value from the processing module as a consequence of sending the positional information to the processing module; and send the received hashed value to an entity for further verification on the collected positional information of the device.

An example (e.g., example 40) relates to a device comprising a processor and a memory storing computer-readable program codes, wherein the processor is, when executing the program codes, configured to: assign, in response to a nonce request, a nonce value for a hash calculation to positional information of a target device; receive a hash result; and determine, based on the hash result, whether the positional information is false.

An example (e.g., example 41) relates to a previously described example (e.g., example 40) or to any of the examples described herein, wherein the determination is based on a first time of receiving the request and a second time of receiving the hash result.

An example (e.g., example 42) relates to a previously described example (e.g., example 40 or 41) or to any of the examples described herein, wherein the determination is based on the nonce value assigned for the request and the received hash result.

An example (e.g., example 43) relates to a method implemented in a secure domain, comprising: determining a reference time value of a reference hash calculation to reference positional information; determining a real time value of a real hash calculation to positional information of a target device; and performing, based on the reference time value and the real time value, a time-related verification on the positional information of the target device.

An example (e.g., example 44) relates to a previously described example (e.g., example 43) or to any of the examples described herein, wherein the reference time value is determined when the security domain is in a low load state.

An example (e.g., example 45) relates to a previously described example (e.g., example 44) or to any of the examples described herein, wherein the real time value is determined when the security domain is in the low load state.

An example (e.g., example 46) relates to a previously described example (e.g., example 44 or 45) or to any of the examples described herein, wherein the low load state refers to a state where a computational workload in the security domain is below 30%, 25%, 20%, 15%, 10%, 5%, or 3%.

An example (e.g., example 47) relates to a previously described example (e.g., any one of examples 43 to 46) or to any of the examples described herein, wherein the reference time value is an average value of a plurality of time values caused by hash calculations of a plurality of pieces of reference positional information.

An example (e.g., example 48) relates to a previously described example (e.g., any one of examples 43 to 46) or to any of the examples described herein, wherein the reference time value is a minimal value of a plurality of time values caused by hash calculations of a plurality of pieces of reference positional information.

An example (e.g., example 49) relates to a previously described example (e.g., any one of examples 43 to 48) or to any of the examples described herein, wherein the method further comprises: sending, upon successful time-related verification, a result of the real hash calculation to a verification entity outside the security domain for at least one different verification.

An example (e.g., example 50) relates to a previously described example (e.g., any one of examples 43 to 49) or to any of the examples described herein, wherein the reference time value refers to a length of a reference time period that starts at receipt of information initiating the reference hash calculation and ends at completion of calculating a hash value based on received positional information and the information initiating the reference hash calculation.

An example (e.g., example 51) relates to a previously described example (e.g., example 50) or to any of the examples described herein, wherein the method further comprises receiving the reference positional information during the reference time period.

An example (e.g., example 52) relates to a previously described example (e.g., example 50 or 51) or to any of the examples described herein, wherein the information initiating the reference hash calculation comprises a first nonce value.

An example (e.g., example 53) relates to a previously described example (e.g., any one of examples 43 to 52) or to any of the examples described herein, wherein the real time value refers to a length of a real time period that starts at receipt of information initiating the real hash calculation and ends at completion of calculating a hash value based on received positional information and the information initiating the real hash calculation.

An example (e.g., example 54) relates to a previously described example (e.g., example 53) or to any of the examples described herein, wherein the method further comprises receiving the real positional information during the real time period.

An example (e.g., example 55) relates to a previously described example (e.g., example 53 or 54) or to any of the examples described herein, wherein the information initiating the real hash calculation comprises a second nonce value.

An example (e.g., example 56) relates to a method, comprising: sending, to a processing module in a security domain, information initiating a hash calculation to positional information of a device; collecting the positional information of the device; and sending the positional information of the device to the processing module for hash calculation.

An example (e.g., example 57) relates to a previously described example (e.g., example 56) or to any of the examples described herein, wherein the device is a reference device, the positional information is reference positional information, and the hash calculation is performed to determine a reference time value.

An example (e.g., example 58) relates to a previously described example (e.g., example 56) or to any of the examples described herein, wherein the device is a target device, the positional information is real positional information, and the hash calculation is performed to determine a real time value.

An example (e.g., example 59) relates to a previously described example (e.g., any one of examples 56 to 58) or to any of the examples described herein, wherein the method further comprises: receiving a request for location validation; sending a request to a server for a nonce value; and receiving the nonce value, wherein the information initiating the hash calculation to positional information of the device comprises the nonce value.

An example (e.g., example 60) relates to a previously described example (e.g., any one of examples 56 to 59) or to any of the examples described herein, wherein the method further comprises: receiving a hashed value from the processing module as a consequence of sending the positional information to the processing module; and sending the received hashed value to an entity for further verification of the collected positional information of the device.

An example (e.g., example 61) relates to a method, comprising: assigning, in response to a nonce request, a nonce value for a hash calculation to positional information of a target device; receiving a hash result; and determining, based on the hash result, whether the positional information is false.

An example (e.g., example 62) relates to a previously described example (e.g., example 61) or to any of the examples described herein, wherein the determination is further based on a first time of receiving the nonce request and a second time of receiving the hash result.

An example (e.g., example 63) relates to a previously described example (e.g., example 61 or 62) or to any of the examples described herein, wherein the determination is further based on the nonce value assigned for the request and the received hash result.

1. A non-transitory machine-readable storage medium including program code, when executed, to cause a machine to implement a processing module in a secure domain, wherein the processing module is configured to:
determine a reference time value of reference hash calculation to reference positional information;
determine a real time value of real hash calculation to positional information of a target device; and
perform, based on the reference time value and the real time value, a time-related verification on the positional information of the target device.

2. The storage medium of claim 1, wherein the reference time value is determined when the security domain is in a low load state.

3. The storage medium of claim 2, wherein the real time value is determined when the security domain is in the low load state.

4. The storage medium of claim 2, wherein the low load state refers to a state where a computational workload in the security domain is below 30%, 25%, 20%, 15%, 10%, 5% or 3%.

5. The storage medium of claim 1, wherein the reference time value is an average value of a plurality of time values caused by hash calculation to a plurality of pieces of reference positional information

6. The storage medium of claim 1, wherein the reference time value is a minimal value of a plurality of time values caused by hash calculation to a plurality of pieces of reference positional information.

7. The storage medium of claim 1, wherein the processing module is further configured to:
send, upon that the time-related verification is successful, a result of the real hash calculation to a verification entity out of the security domain for at least one different verification.

8. The storage medium of claim 1, wherein the reference time value refers to a length of a reference time period that starts at receipt of the information initiating the reference hash calculation and ends at an end of calculating a hash value based on received positional information for the reference hash calculation and received information initiating the reference hash calculation.

9. The storage medium of claim 8, wherein the processing module is configured to receive the positional information of the reference positional information during the reference time period.

10. The storage medium of claim 8, wherein the information initiating the reference hash calculation comprises a first nonce value.

11. The storage medium of claim 1, wherein the real time value refers to a length of a real time period that starts at receipt of the information initiating the real hash calculation and ends at an end of calculating a hash value based on received positional information for the real hash calculation and received information initiating the real hash calculation.

12. The storage medium of claim 11, wherein the processing module is configured to receive the positional information of the real positional information during the real time period.

13. The storage medium of claim 11, wherein the received information initiating the real hash calculation comprises a second nonce value.

14. A non-transitory machine-readable storage medium including program code, when executed, to cause a machine to:
send a processing module in a security domain information initiating hash calculation to positional information of a device;
collect the positional information of the device; and
send the positional information of the device to the processing module for hash calculation.

15. The storage medium of claim 14, wherein the device is a reference device, the positional information is reference positional information, and the hash calculation is hash calculation for determining a reference time value.

16. The storage medium of claim 14, wherein the machine is further caused by the program code to:
receive a request for location validation;
send a request to a server for a nonce value; and
receive the nonce value, wherein the information initiating hash calculation to positional information of a device comprises the nonce value.

17. The storage medium of claim 14, wherein the machine is further caused by the program code to:
receive a hashed value from the processing module as a consequence of sending the positional information to the processing module; and
send the received hashed value to an entity for further verification on the collected positional information of device.

18. A non-transitory machine-readable storage medium including program code, when executed, to cause a machine to:
assign, in response to a nonce request, a nonce value for a hash calculation to positional information of a target device;
receive a hash result; and
determine, based on the hash result, whether the positional information is false.

19. The storage medium of claim 18, wherein the determination is based on a first time of receiving the request and a second time of receiving the hash result.

20. The storage medium of claim 18, wherein the determination is based on the nonce value assigned for the request and the received hash result.
